(19) United States
(12) Patent Application Publication
(10) Pub. No.: US 2004/0195908 A1
(43) Pub. Date: Oct. 7, 2004

(54) Tubular spoked wheel

(76) Inventor: Bernard Denis Main, Soldotna, AK (US)

Correspondence Address: Bernard Main, P.O. Box 152, Soldotna, AK, 99669, US

(21) Appl. No.: 10/407,962

(22) Filed: Apr. 3, 2003

(51) Int. Cl. B60B 1/06

(52) U.S. Cl. 301/80

(57) ABSTRACT

My invention is the Tubular Spoked Wheel, designed to appear like an old fashioned wooden wheel but with many advantages. For instance, it is not affected by wet and dry weather and it is readily adaptable to lug bolt mounting. It can be adapted to almost any application such as: automobile, motorcycle, bicycles, and different materials such as welded steel construction, or a one piece aluminum casting machined.

### CROSS REFERENCE TO RELATED APPLICATIONS

Not Applicable

### REFERENCE TO SEQUENCE LISTING, A TABLE OR COMPUTER PROGRAM L.ISTING COMPACT DISK APPENDIX

Not Applicable

### BACKGROUND OF THE INVENTION

The tubular spoked wheel for automobile, motorcycle, and bicycle: Made to cause a different appearance, adding a touch of nostalgia.

### BRIEF SUMMARY OF THE INVENTION

I wanted to build a metal wheel with the appearance of the old wooden wheel, for use with automobiles, motorcycles, and bicycles. For automobile use it can be mounted on lug bolts. The motorcycle wheel and bicycle wheel have a variation in hubs to accommodate the specific type of service.

### BRIEF DESCRIPTION OF THE SEVERAL VIEWS OF THE DRAWING

FIG. 1 shows the automobile wheel with a front view and also the side view cut in half.

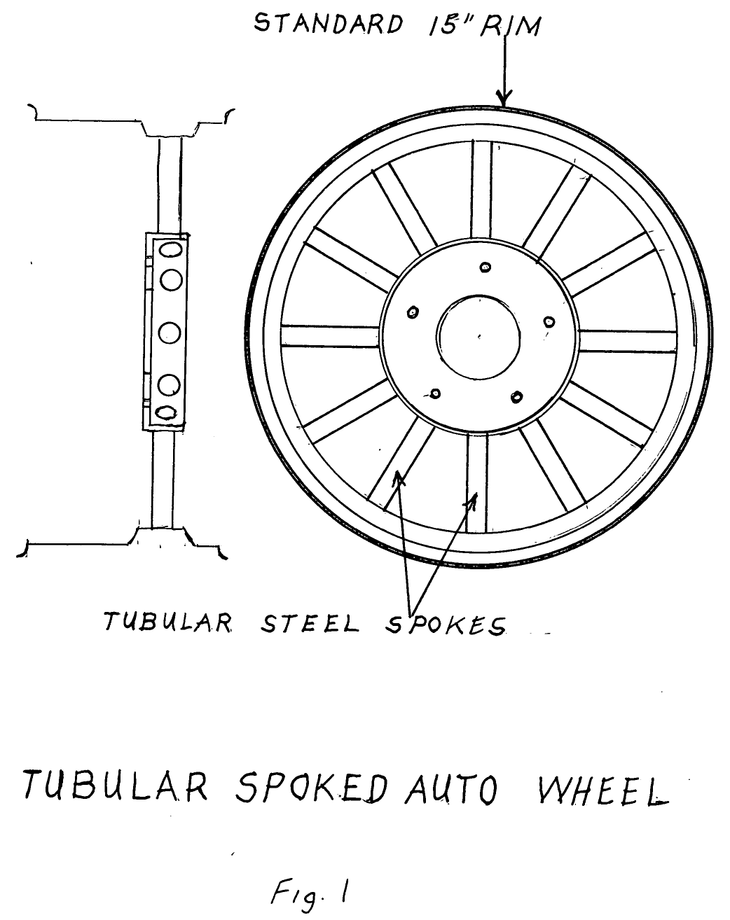

FIG. 2 shows the hub of the wheel, showing the lug bolt holes and also the twelve holes through which the tubular spokes are to be welded.

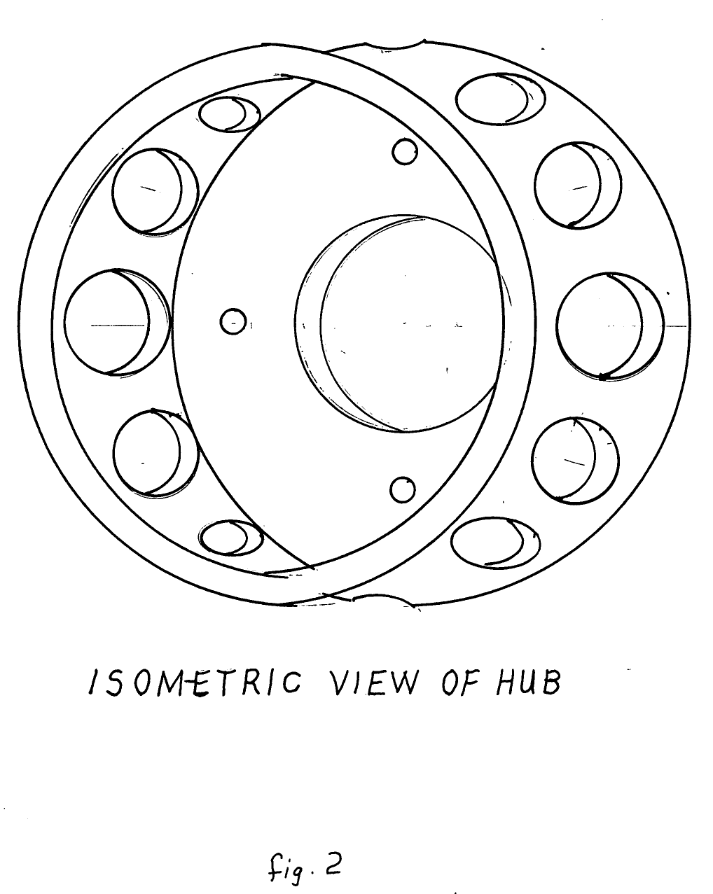

FIG. 3 shows a detailed view of the weld bevels on the hub and welding details.

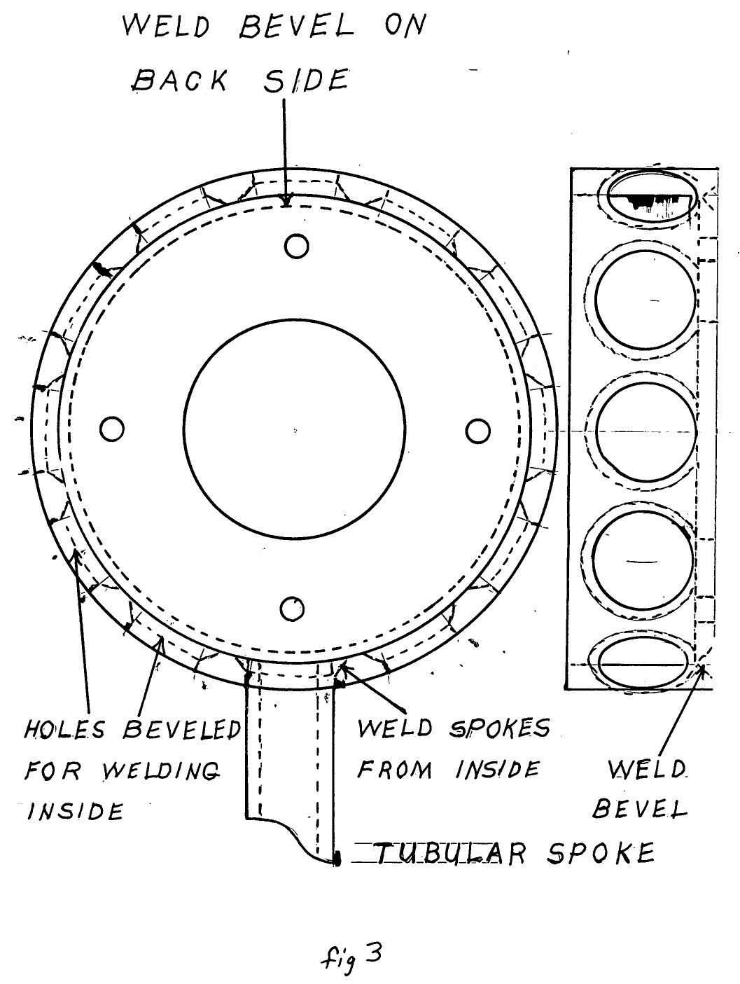

FIG. 4 shows welding details of the spokes to the rim

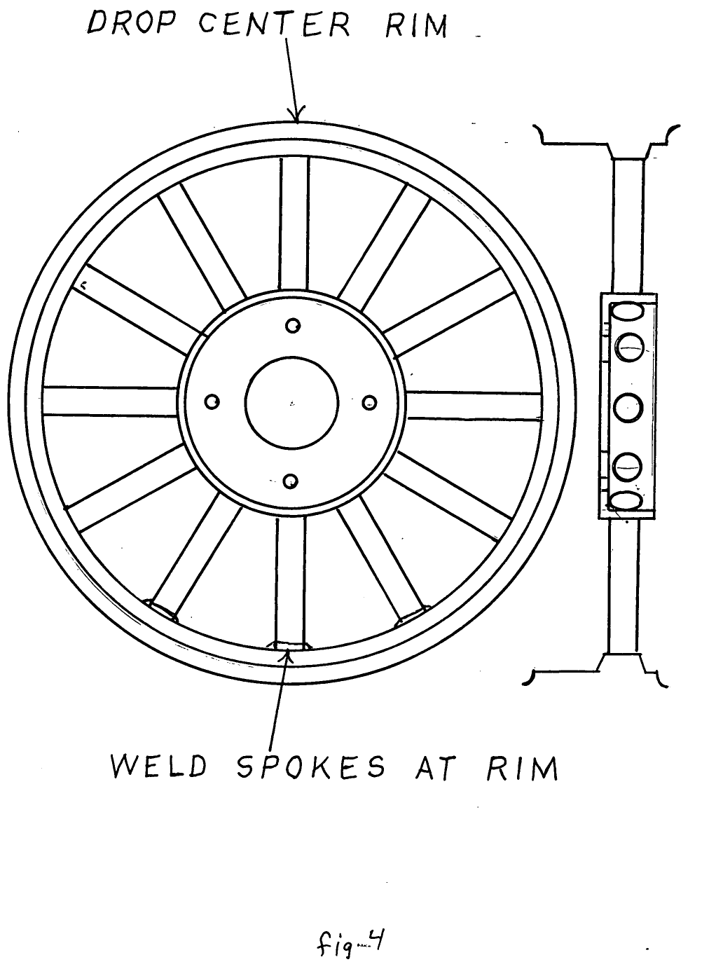

FIG. 5 shows the hubcap for the automobile wheel with detail of mounting screw holes.

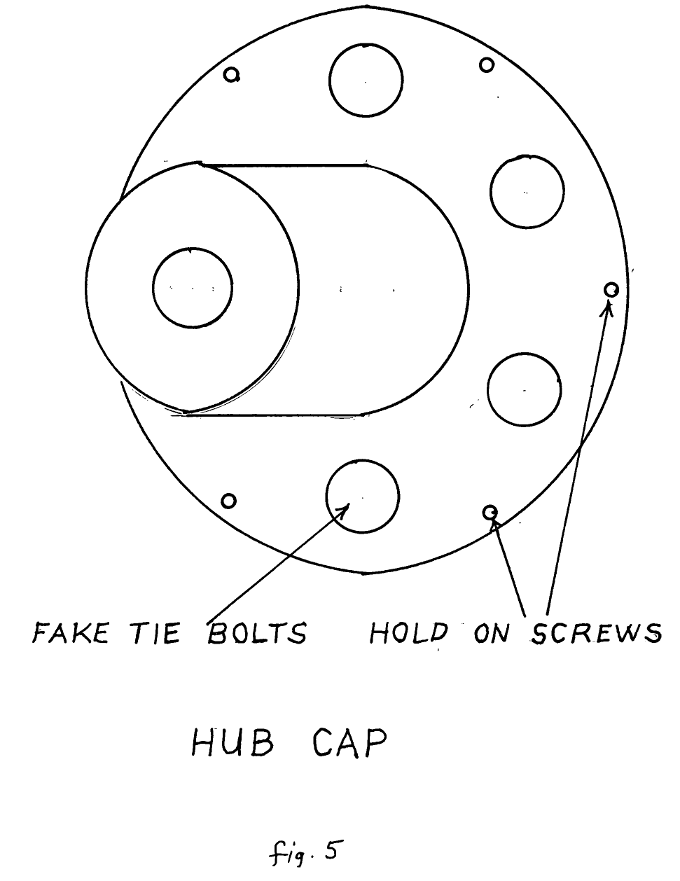

FIG. 6 shows how with some changes at the hub the wheel can be adapted for motorcycle use.

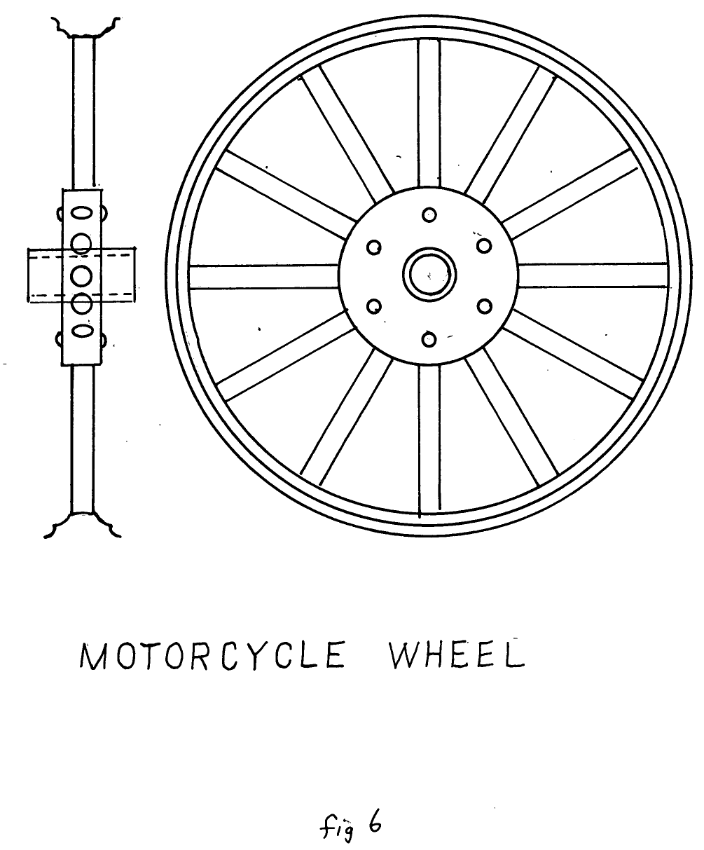

FIG. 7 by using lighter materials the Tubular Spoked Wheel can easily be built for bicycle use.

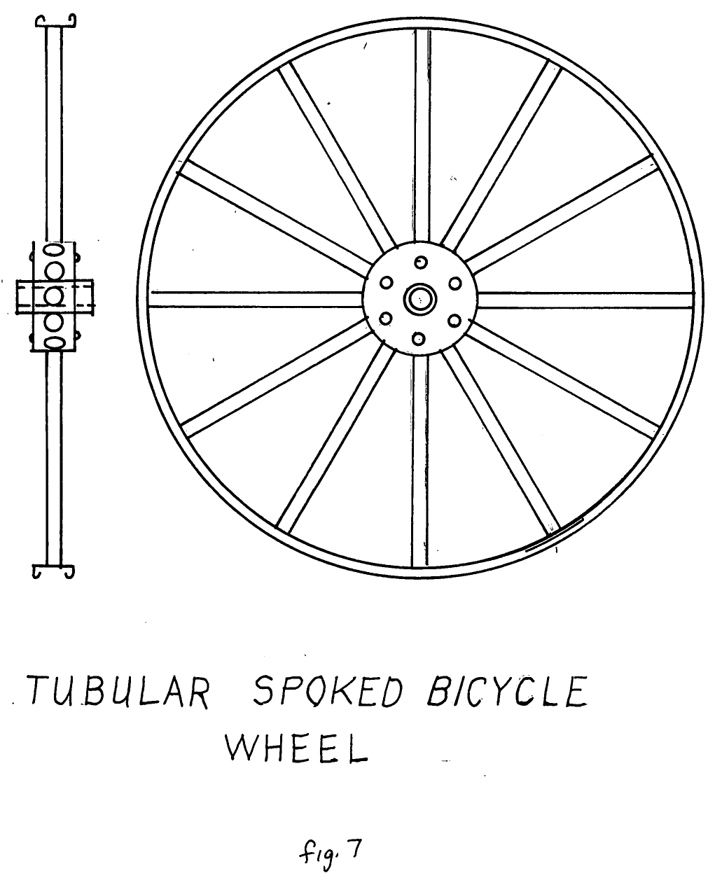

### DETAILED DESCRIPTION OF THE INVENTION

I always liked the look of wooden spoked wheels. Though I liked them, I felt they had Many disadvantages such as:

1. Short lived when exposed to the weather

2. Troublesome, dry out and get loose and they were subject to wear when loose.

3. Not adaptable to mounting with lug bolts

My Idea: To build a metal wheel appearing similar to the wooden wheel.

What would make a good spoke? I realized they had to be thick enough to Get a good weld and strong enough to carry the load. Though these wheels can Be made of different kinds of materials, for my first try, I used 1″ black pipe, 1 5/16″ diameter and ⅛″ thick. It worked very well

What would make a good hub, a more practical hub for today's applications? The hub would have to be able to fit any lug patterns. These wheels are easily adaptable to this. I built the first wheel to fit Ford's 5 hole lug pattern. I used 6″ pipe because it would house the lug bolts and it was the right size for the hub. I cut a 1¾″ length from a 6″ diameter pipe. To accommodate the lugs, I cut a 6″ circle from ¼″ steel plate. I bored the center hole and 5 additional holes using the Ford lug pattern. Then I welded this circle into one side of the 6″ pipe.

How to attach the spokes? I divided the circumference into twelve equal parts and drilled 1 5/16″ holes all around the hub . The hub was now complete.

What will I use for the rim? I cut the web out of a 15×5½″ drop center rim, leaving only the rim. By using the hub and rim, I was able to determine how long to make the spokes. I then cut 12 equal spokes, adding ⅛″ for trimming. Next, I proceeded to weld the spokes into the hub welding only on the inside to keep it clean looking on the outside. At this point, the spokes had to be trimmed to length. I now setup the hub up in the lathe and began taking cuts on all the spokes, checking till I got a tight fit inside the rim. With a hammer, I aligned the rim till it ran true with the hub. Upon removing the assembly from the lathe, I proceeded to weld around each spoke at the rim. These welds were dressed up with a die grinder.

The next thing was to provide a hub cap. I machined a disk, ¼″ thick, 6⅝″ diameter, to cover the face of the hub, boring a 2⅜″ center hole. Next, I cut a length of 2½″ from a 2″ pipe to extend from the hub, and welded it into the disc from the back side. I then machined a brass plug and pressed it into the exposed end of the 2″ pipe. This brass plug can be engraved with identification or a trade mark and also carry lettering. I drilled six holes and installed dummy bolt heads to resemble tie bolts.

How to attach the hubcap? After considering springs, I chose to use screws since the edge of the hub is so thin there is only room for small screws. I chose # 8 machine screws. I drilled 6 holes in the outer edge of the hub cap and also into the hub. I tapped the holes with #8-32 threads and secured the hubcap with 6 8-32×½″ machine screws. It is now done and ready for painting

My Idea: To build Tubular Spoke Bicycle Wheel.

This would require light materials, so I used ⅝″ thin wall steel tubing for the spokes. I used a 1¼ length of thin steel tubing, 3½″ in diameter, for the hub. Following the same procedures as I did with the car wheel, I built two twenty inch bicycle wheels.

My Idea: The same construction can be used for Motorcycle wheels. The hub would be altered to accept the bearings and axle shaft of the motorcycle.

1. What I claim as my invention is The Tubular Spoked Wheel, mountable on standard lug bolts and furnished with a standard drop center rim, for automobile use.

2. I also claim that by making alterations to the hub, it can be adapted for motorcycle use.

3. I also claim that the same construction is adaptable for bicycle use, using much lighter materials in construction.

4. I also claim that this wheel could be made from a single alloy casting, machined.
